(19) United States
(12) Patent Application Publication
(10) Pub. No.: US 2016/0203477 A1
(43) Pub. Date: Jul. 14, 2016

(54) CRYPTOGRAPHIC SECURITY FOR ELECTRONIC TRANSACTIONS

(71) Applicant: Modernity Financial Holdings, Ltd., Palo Alto, CA (US)

(72) Inventors: Danny Yang, Palo Alto, CA (US); Liqin Kou, Palo Alto, CA (US); Alex Liu, Shanghai (CN); Yu-Te Lin, Taiwan (TW)

(21) Appl. No.: 14/995,526

(22) Filed: Jan. 14, 2016

Related U.S. Application Data
(60) Provisional application No. 62/103,318, filed on Jan. 14, 2015.

(51) Int. Cl. G06Q 20/36; G06Q 20/38

(52) U.S. Cl. CPC G06Q 20/3678; G06Q 20/381; G06Q 20/3829

(57) ABSTRACT

Various embodiments include a wallet service that processes a cryptocurrency deposit into a cryptocurrency wallet account maintained in a wallet service system. The wallet service can receive an authentication parameter to authenticate the cryptocurrency deposit and record a transfer of a cryptocurrency amount from a first cryptocurrency address to a second cryptocurrency address. In response to and substantially immediately after authenticating the authentication parameter, the wallet service can exchange the cryptocurrency amount associated with the cryptocurrency deposit for fiat currency proceeds and deposit the fiat currency proceeds into a fiat reserve account. The wallet service can then associate exchangeable credit equal to the fiat currency proceeds to the cryptocurrency wallet account. In response to receiving a user-initiated request to spend a target portion of the exchangeable credit, the cryptocurrency wallet service can exchange, from the fiat reserve account, for cryptocurrency proceeds equal to the target portion.

### CROSS-REFERENCE TO RELATED APPLICATION(S)

This application claims the benefit of U.S. Provisional Patent Application No. 62/103,318, entitled “CRYPTOGRAPHIC SECURITY FOR ELECTRONIC TRANSACTIONS,” filed on Jan. 14, 2015, which is incorporated by reference herein in its entirety.

### RELATED FIELD

At least one embodiment of this disclosure relates generally to electronic transaction systems, and in particular to electronic transaction system involving cryptocurrency.

### BACKGROUND

Various types of computer network systems are employed to facilitate electronic transactions that transfer value between at least two accounts. In designing a computer system to facilitate electronic transactions, privacy, security, and efficiency are often the primary concerns. The modern day electronic transaction computer systems support financial institutes by making digital records of electronic transactions. However, the data security of these electronic transaction systems depends on third party systems to authenticate every electronic transaction that transfers something of value. Some of these third parties may modify the content of the electronic transaction. These requirements inevitably spread the information relating an electronic transaction to more entities and inevitably delay the actual transference of value. Conventional electronic transaction systems for financial institutions face the technical problems of computer security breaches (e.g., from third-party systems) and transaction latency.

### BRIEF DESCRIPTION OF THE DRAWINGS

FIG. 1 is a block diagram of an operating environment of a wallet service server system, in accordance with various embodiments.

FIG. 2 is a block diagram illustrating logic components of the wallet service server system, in accordance with various embodiments.

FIG. 3 is a flow chart of a method of operating a wallet service server system to secure electronic transactions, in accordance with various embodiments.

FIG. 4 is a block diagram of an example of a computing device, which may represent one or more computing device or server described herein, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

“Currency” refers to money that can use in circulation as a medium of exchange representing quantified value. “Fiat currency” refers to money that derives its value from government regulation or law. A “virtual currency” refers to a medium of exchange that is electronically created and stored. A “cryptocurrency” is a type of virtual currency. Cryptocurrency, such as Bitcoin, refers to a digital medium of exchange that uses cryptography for security and prevention of counterfeiting and/or fraud. Cryptocurrency can be implemented in a distributed manner across a network of computing devices that maintains a digital banking ledger, such as in the form of a block chain. The block chain is a shared public ledger on which the cryptocurrency network relies. Electronic transactions of cryptocurrency can be confirmed into the block chain utilizing a distributed consensus system. The integrity and the chronological order of blocks (e.g., each block storing one or more electronic transactions that are deemed to occur simultaneously) in the block chain are enforced with cryptography.

An electronic transaction can occur between cryptocurrency wallets. When the electronic transaction is initiated, it is propagated through the cryptocurrency network and eventually incorporated in a block of the block chain by a miner entity in the cryptocurrency network.

A “hot wallet” or a “hot wallet service” herein refers to implementation of a virtual currency wallet that is accessible online via the Internet, providing users a portal to initiate electronic transactions within a virtual currency economy. For example, cryptocurrency-related services and exchanges that are able to spend or pay out withdrawals instantly can be said to be paying them from a “hot wallet service.” The hot wallet service can be implemented by one or more computer servers storing one or more private keys that can authorize electronic transactions to a cryptocurrency network.

“Mining” herein refers to a distributed consensus system in a cryptocurrency network that is used to confirm waiting transactions by including them in the block chain. The process of mining enforces a chronological order in the block chain, protects the neutrality of the cryptocurrency network, and allows different computers to agree on the state of the cryptocurrency system. To be confirmed and/or authenticated, transactions must be packed in a block that fits strict cryptographic rules that will be verified by the cryptocurrency network. These rules prevent previous blocks from being modified because doing so would invalidate all following blocks. Mining also creates the equivalent of a competitive lottery that prevents any individual from easily adding new blocks consecutively in the block chain. This way, no individuals can control what is included in the block chain or replace parts of the block chain to roll back their own spends. “Miner” herein refers to an entity that participates in the mining activity by attempting to cryptographically solve a computational challenge required to generate a new block.

Several embodiments include a computer system that facilitates electronic transactions of value by utilizing a dynamic cryptocurrency conversion mechanism. The computer system advantageously simulates a fiat currency bank system utilizing cryptocurrency block chain as the underlying backend system. The computer system can shield users of the computer system from the exchange rate volatility between cryptocurrency and fiat currency.

For example, the computer system implements a wallet service that generates a wallet interface (e.g., a web-based or mobile user interface) to enable user devices (e.g., authenticated to represent respective wallet accounts) to make deposits, withdrawals, and spend cryptocurrency. The wallet service can measure the value in the wallet account as fiat currency.

When making a deposit via the wallet interface, a user associated with a wallet account can provide authentication parameters to the wallet service to verify authority to fund the deposit. In some embodiments, the authentication parameters include cryptographic proof of ownership of cryptocurrency that is being deposited. In some embodiments, the authentication parameters authorize the wallet service to act as a broker to purchase cryptocurrency using fiat currency from a financial account associated with the user. For example, the computer system can purchase cryptocurrency on behalf of the wallet account, in response to receiving authentication parameters for a deposit transaction.

In several embodiments, immediately after a deposit transaction, the wallet service determines a fiat currency type to associate with the wallet account. For example, the wallet service can determine the fiat currency type by querying the user via the wallet interface. For another example, the wallet service can determine the fiat currency type based on user location, user behavior, user profile in a social network, or fiat currency type associated with a financial account that funded the purchase of the cryptocurrency.

In response to the deposit transaction, the wallet service can immediately sell the deposited or purchased cryptocurrency via a cryptocurrency exchange (e.g., by communicating with an exchange server). The exchange server, for example, can be part of the computer system (e.g., a brokerage service implemented by the computer system) or an external computer system on an external network. In some embodiments, the wallet service can attempt to trade the cryptocurrency in multiple exchange servers and select the best one or more of the exchange servers that maximize the fiat currency proceeds, maximizes security, maximizes availability, and/or maximizes privacy. The fiat currency proceeds from the sale of the cryptocurrency can be stored in a reserve account associated with the wallet service. The proceeds can be measured in units of the determined fiat currency type. In turn, the computer system records a credit to the wallet account, where the credit is measured in units of the determined fiat currency type.

The computer system can generate and maintain the wallet interface for users to withdraw cryptocurrency from the wallet account, deposit value (e.g., as fiat currency or cryptocurrency) into the wallet account, and spend the credit of the wallet account. The amount available from the wallet account is locked at a value measured in the determined fiat currency type. This enables the fiat value of a wallet account to remain constant, even as the exchange rate between the fiat currency type and the cryptocurrency type changes. In some embodiments, the wallet interface can present the wallet account balance in the determined fiat currency type. In some embodiments, the wallet interface can present the wallet account balance in both the determined fiat currency type and a cryptocurrency type (e.g., from one or more cryptocurrency types associated the wallet service) in accordance with a current exchange rate between the determined fiat currency type and the cryptocurrency type. That is, the cryptocurrency balance is dynamically calculated based on the exchange rate (e.g., in real-time).

Whenever a withdraw operation or a spending operation (e.g., cross-border remittance/transfer) is initiated by a user associated with the wallet account, the computer system can, in real-time, purchase cryptocurrency at the time of the user-initiated request up to the amount of the credit recorded for the wallet account. The purchased cryptocurrency is then used in a cryptocurrency transaction that transfers cryptocurrency to another cryptocurrency address of the user (e.g., withdraw operation) or of a third party (e.g., spend operation). In some embodiments, the wallet service can attempt to purchase the cryptocurrency in multiple exchange servers and select the best one or more of the exchange servers that maximize the cryptocurrency proceeds, maximizes security, maximizes availability, and/or maximizes privacy. In some embodiments, a selected exchange server is part of the computer system. In some embodiments, the selected exchange server is on an external network from the computer system.

In several embodiments, the purchase of the cryptocurrency is funded by the reserve account associated with the wallet service. The computer system can deduct the credit of the wallet account (e.g., measured in units of the determined fiat currency type) by the value the user spends or withdraws (e.g., the value associated with the withdraw operation or the spending operation).

In various implementations of cryptocurrency, exchange rates between cryptocurrency and fiat currency can fluctuate at a much greater variance as compared to exchange rates between different fiat currencies. The computer system advantageously shelters the wallet account from the exchange rate volatility between cryptocurrency and fiat currency.

In some embodiments, the wallet service can charge a fee for this wallet service. For example, the fee can be applied at time of deposit, withdrawal, or scheduled intervals. The fee can be charged in set units of fiat currency, set units of cryptocurrency, a percentage of total in the wallet account (e.g., as measured in units of fiat currency or as measured in units of cryptocurrency), or any combination thereof.

The computer system can implement a wallet interface of the wallet service as a mobile or web interface. In some embodiments, the concept of cryptocurrency is hidden from the user on the wallet interface so the users are not confused by the wallet service. For these users, they just know they have a wallet where they can store and use the fiat value they deposit. They can spend this fiat value and transfer them over to other users using one or more cryptocurrency networks. In these cases, the step of purchasing cryptocurrency from an exchange server using fiat currency in a reserve account of the wallet server may be obfuscated from the user.

The disclosed wallet service advantageously provides a seamless system to receive and spend cryptocurrency without the users ever realizing that cryptocurrency is involved and without the volatility of the cryptocurrency exchange rate. The disclosed computer system implementing the wallet service (e.g., to automatically buy and sell cryptocurrency) further retains the security benefits and processing time savings associated with using a cryptocurrency network.

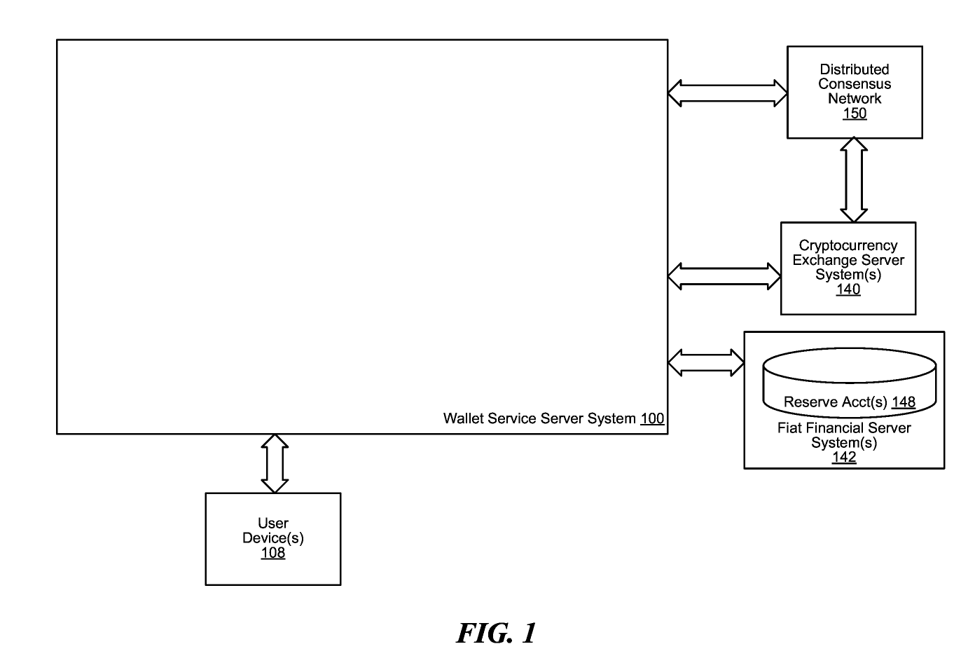

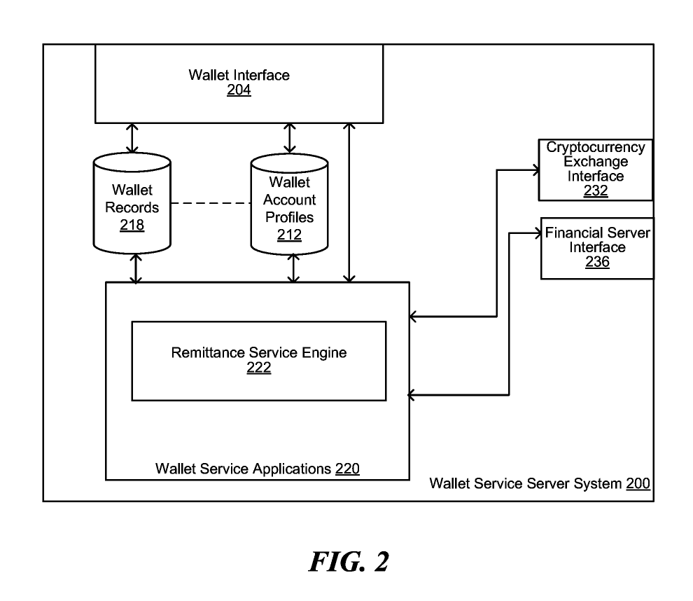

FIG. 1 is a block diagram of an operating environment of a wallet service server system 100, in accordance with various embodiments. The wallet service server system 100 can provide a hot wallet service to one or more user accounts (e.g., “wallet accounts”) associated with one or more user devices 108. For example, the wallet service server system 100 can be a wallet service server system 200 of FIG. 2. The wallet service server system 100 can perform various wallet services, including a remittance service that makes payments between wallet accounts (e.g., wallet accounts within the wallet service server system 100 or a wallet account of the wallet service server system 100 and a wallet account of an external wallet service) utilizing cryptocurrency. For example, the hot wallet service provided by the wallet service server system 100 can communicate with one or more of the cryptocurrency exchange server systems 140 and one or more fiat financial server systems 142 to implement a remittance mechanism in accordance with various embodiments.

Each of the cryptocurrency exchange server systems 140 can be coupled to and in communication with a distributed consensus network 150. The distributed consensus network 150 can maintain a public ledger that is cryptographically verifiable. For example, the public ledger can be implemented as a block chain. In some embodiments, the cryptocurrency exchange server systems 140 include one or more exchange servers that are within the wallet service server system 100. The block chain is primarily tamper resistant through timestamping the hash of batches of recent valid cryptocurrency transactions (e.g., from one cryptocurrency address to another cryptocurrency address) into “blocks”, proving that the data must have existed at the time. In some embodiments, the ownership of a cryptocurrency address can be verified by providing a cryptographic signature that is verifiable by a public key associated with the cryptocurrency address. Each block can include the prior timestamp, forming a chain of blocks, with each additional timestamp reinforcing the ones before it. Each block chain record is enforced cryptographically and hosted on machines working as data store nodes extending this validation to the network as a whole. The validity of a block can be demonstrated via a proof-of-work process.

A proof of work is a piece of data which is difficult (e.g., costly and time-consuming in terms of computational resource) to produce, but easy for others to verify that the data satisfies certain requirements. Producing a proof of work can be a random process with low probability so that a lot of trial and error is required on average before a valid proof of work is generated. In order for a block to be accepted by network participants of the distributed consensus network 150, a computer proposing a new block must complete a proof-of-work cryptographic puzzle which covers all of the data in the block.

The fiat financial server systems 142 can provide financial services that store fiat currency for one or more of its user accounts. For example, the fiat financial server systems 142 can include a computer system of a bank, an online payment system, a computer system of an investment institute, or any combination thereof. At least one of the fiat financial server systems 142 can maintain a reserve account 148 on behalf of the wallet service server system 100. For example, a wallet account in the wallet service server system 100 can have a corresponding reserve account of fiat currency in one of the fiat financial server systems 142.

In some embodiments, the fiat financial server systems 142 can only record transfers of fiat currency from one account to another. In some embodiments, the distributed consensus network 150 can only record transfers of cryptocurrency from one cryptocurrency address to another. In some embodiments, the cryptocurrency exchange server systems 140 can record exchanges of cryptocurrency to fiat currency and vice versa. In some embodiments, the wallet service server system 100 can process user-initiated requests to send payments utilizing cryptocurrency, while utilizing the disclosed remittance mechanism. The disclosed remittance mechanism can fund the cryptocurrency transfers between wallet accounts utilizing real-time conversion from fiat currency in the reserve account 148 into cryptocurrency for the user-initiated requests. In some embodiments, multiple wallet account can share the same reserve account.

FIG. 2 is a block diagram illustrating logic components of the wallet service server system 200, in accordance with various embodiments. The wallet service server system 200 can include a wallet interface 204. The wallet interface 204 is configured to provide an interactive user interface for wallet accounts (e.g., user accounts of the wallet service server system 200). The wallet interface 204 may be accessible as one or more application programming interfaces (APIs) and/or a website comprised of one or more webpages (e.g., formatted in HTML, Flash™, Java Applet, JavaScript, etc.). User devices, such as the user devices 108, can utilize native applications to access the APIs of the wallet interface 204. The user devices can also utilize web browsers to access the website of the wallet interface 204.

The wallet interface 204 can have access to wallet account profiles 212 and wallet records 218. The wallet account profiles 212 and the wallet records 218 can be stored in different databases or the same database. The wallet account profiles 212 can cache authentication parameters or cryptographic parameters used to verify the identity of a wallet account user, the ownership of a cryptocurrency address (e.g., in the distributed consensus network 150), and/or the ownership of a fiat currency account. The wallet records 218 can store the accounting balances of the wallet accounts. In some embodiments, the account balance is measured according to a fiat currency type (e.g., specified by the wallet user), even though user-initiated transactions are transmitted using cryptocurrency.

The wallet service server system 200 can include one or more wallet service applications 220. For example, the wallet service applications 220 can include a remittance service engine 222. In some embodiments, a user account of the wallet service server system 200 can initiate a cryptocurrency deposit into a wallet account via the wallet interface 204. In some cases, the user-initiated cryptocurrency deposit can indicate a source of cryptocurrency from another wallet account (e.g., of the same wallet service server system 100 or another wallet service server system). In these cases, the cryptocurrency deposit can be a direct deposit of cryptocurrency, and the remittance service engine 222 can process the cryptocurrency deposit by adjusting the account balances of the source wallet account and the requesting wallet account.

In some cases, the user-initiated cryptocurrency deposit can utilize a fiat currency account as the source of the cryptocurrency deposit. In these cases, the remittance service engine 222 can automatically convert fiat currency into cryptocurrency for deposit. For example, the remittance service engine 222 can query the user via the wallet interface 204 for authentication parameters associated with a fiat currency account in a fiat financial server system (e.g., one of the fiat financial server systems 142). In some embodiments, the remittance service engine 222 can retrieve the authentication parameters from the wallet account profiles 212. In these cases, the remittance service engine 222 can automatically convert, on behalf of the requesting wallet account, fiat currency from the fiat currency account into cryptocurrency for deposit. For example, the remittance service engine 222 can execute the conversion into cryptocurrency via a cryptocurrency exchange interface 232, which interfaces with one or more cryptocurrency exchange server systems (e.g., cryptocurrency exchange server systems 140).

In several embodiments, in response to processing and verifying the deposit of cryptocurrency (e.g., directly or by purchasing cryptocurrency first), the remittance service engine 222 can substantially immediately exchange the cryptocurrency deposit (e.g., via the cryptocurrency exchange interface 232) for fiat currency proceeds of a fiat currency type (e.g., selected by the requesting wallet account making the cryptocurrency deposit). The fiat currency proceeds from exchanging the cryptocurrency is accounted into a reserve account (e.g., the reserve account 148) in a fiat financial server system (e.g., the fiat financial server systems 142). The remittance service engine 222 can communicate with the fiat financial server system via a financial server interface 236. For example, the remittance service engine 222 can deposit the fiat currency proceeds into the reserve account 148. The remittance service engine 222 can further record an exchangeable credit in an entry in the wallet records 218 and associate the exchangeable credit with the requesting wallet account. Any time after the exchangeable credit is recorded into the wallet records 218, the requesting wallet account can withdraw or spend from the requesting wallet account for an amount within the available exchangeable credit as measured in units of the fiat currency type.

Functional components (e.g., interfaces, engines, modules, and data storage) associated with the wallet service server system 100 and/or the wallet service server system 200 can be implemented as circuitry, firmware, software, or other functional instructions. For example, the functional components can be implemented in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). The systems, engines, or devices described may include additional, fewer, or different functional components for various applications.

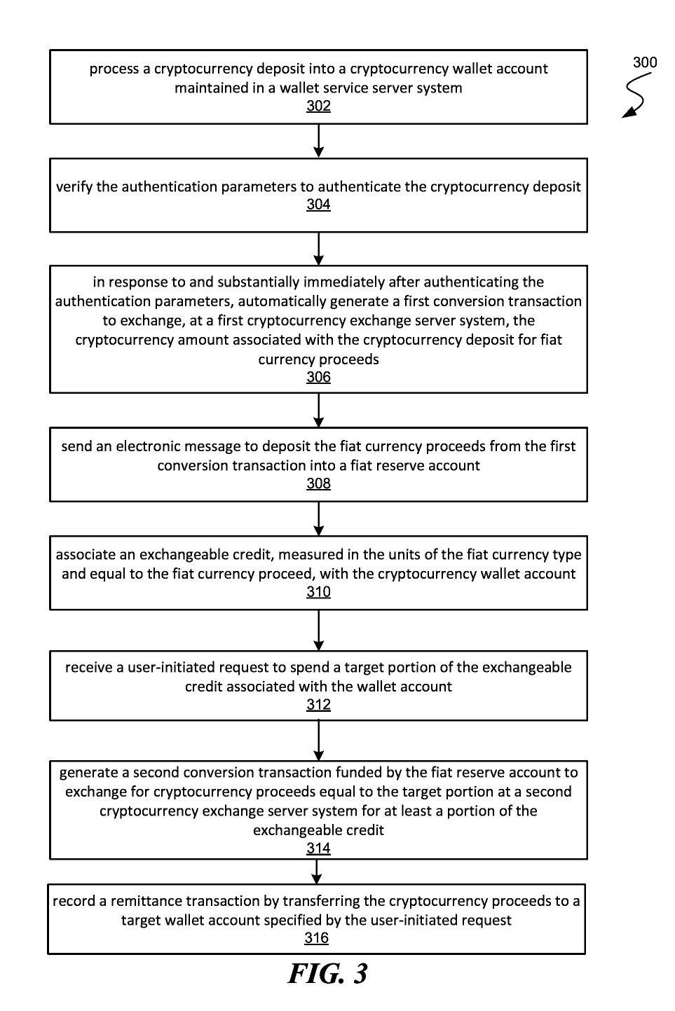

FIG. 3 is a flow chart of a method 300 of operating a wallet service server system (e.g., the wallet service server system 100) to secure electronic transactions, in accordance with various embodiments. At step 302, the wallet service server system can process a cryptocurrency deposit into a cryptocurrency wallet account maintained in a wallet service server system. Processing the deposit can include receiving one or more authentication parameters to verify/authenticate the deposit. Processing the cryptocurrency deposit can include recording a transfer of a cryptocurrency amount from a first cryptocurrency address to a second cryptocurrency address, where the second cryptocurrency address corresponds to the cryptocurrency wallet account in a public ledger maintained by a distributed consensus system. The public ledger can be a chain of transaction record blocks. A sequential order of the transaction record blocks can be verifiable utilizing a proof-of-work process.

In some embodiments, processing the cryptocurrency deposit includes determining the fiat currency type by querying for a user selection on a wallet interface of the wallet service. In some embodiments, processing the deposit includes identifying the fiat currency type based on an account profile of the wallet account.

At step 304, the wallet service server system can verify the authentication parameters (e.g., against an external server) to authenticate the cryptocurrency deposit. In some embodiments, the deposit is associated with and sourced from a cryptocurrency address. In these embodiments, verifying the authentication parameters includes authenticating a cryptographic signature against a corresponding public key associated with the cryptocurrency address in a cryptocurrency network. In some embodiments, processing the deposit includes generating an electronic transaction to purchase the cryptocurrency associated with the deposit, at a third cryptocurrency exchange server, using fiat currency deposit from a financial account. In these embodiments, verifying the authentication parameters includes authenticating the financial account.

At step 306, in response to and substantially immediately after authenticating the authentication parameters, the wallet service server system can automatically generate a first conversion transaction to exchange, at a first cryptocurrency exchange server system, the cryptocurrency amount associated with the cryptocurrency deposit for fiat currency proceeds. Also in response, the wallet service server system can deposit the fiat currency proceeds from the first conversion transaction into a reserve account. In some embodiments, records of the reserve account, measured in units of fiat currency, are maintained at an external financial service server (e.g., one of the fiat financial server systems 142).

The verification of the authentication parameters can be performed substantially immediately before the generation of the first conversion transaction. The fiat currency proceeds can be measured in units of a fiat currency type. In some embodiments, step 306 can include the wallet service server system selecting the first cryptocurrency exchange server from amongst multiple exchange servers to maximize the fiat currency proceeds based on exchange rates provided by the exchange servers.

At step 308, the wallet service server system can send an electronic message to deposit the fiat currency proceeds from the first conversion transaction into a fiat reserve account. The fiat currency proceeds can be measured in units of the selected fiat currency type.

At step 310, the wallet service server system can associate an exchangeable credit with the cryptocurrency wallet account. For example, the exchangeable credit can be measured in the units of the fiat currency type and equal to the fiat currency proceeds. In some embodiments where the cryptocurrency deposit is funded with a fiat currency account, the fiat currency used to fund the cryptocurrency deposit can be substantially equal to the fiat currency proceeds.

At step 312, the wallet service server system can receive a user-initiated request to spend a target portion of the exchangeable credit associated with the wallet account. In response to step 312, at step 314, the wallet service server system can generate a second conversion transaction funded by the fiat reserve account to exchange for cryptocurrency proceeds equal to the target portion at a second cryptocurrency exchange server system for at least a portion of the exchangeable credit. The wallet service server system can deduct the target portion from the exchangeable credit. In some embodiments, step 314 can include the wallet service server system selecting the second cryptocurrency exchange server from amongst multiple exchange servers to maximize the cryptocurrency proceeds based on exchange rates provided by the exchange servers in real-time. In some embodiments, the first cryptocurrency exchange server, the second cryptocurrency exchange server, and/or the third cryptocurrency exchange server can be the same exchange server or different exchange servers.

At step 316, the wallet service server system can complete the user-initiated request by recording a remittance transaction by transferring the cryptocurrency proceeds to a target wallet account. The target wallet account can be specified by the user-initiated request. For example, the target wallet account can be a wallet account in the wallet service server system or in an external wallet service server system.

In several embodiments, the wallet service provides end-to-end obfuscation of cryptocurrency when performing electronic transactions to transfer value over a cryptocurrency network (e.g., a bitcoin network). In some embodiments, the wallet service can limit wallet accounts from withdrawing fiat currency from the wallet accounts. The automatic purchasing and selling of cryptocurrency has the advantage of being independent of exchange rate between cryptocurrency and a form of fiat currency. The automatic purchasing and selling of cryptocurrency also has the advantage of being able to independently process an electronic transaction to transfer value without authenticating the electronic transaction with an external bank. For example, existing digital means of transferring value over the web (e.g., PayPal™ or Apple Pay™) either lack the security available through a cryptocurrency network or require that at least one of the accounts involving the electronic transaction be associated with a bank account. This type of wallet service has further privacy and security benefits because the users can take advantage of the borderless nature of cryptocurrency networks. Users of the wallet service do not have to sign up and register private information in order to use the wallet service. Users can also easily transact with other users who are not using the wallet service. Accordingly, the disclosed wallet service reduces the complexity and volatility normally involved with the use of cryptocurrency networks while utilizing the increased security, privacy, and reach/availability of the cryptocurrency network.

While processes or blocks are presented in a given order in the flow diagram of this disclosure, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

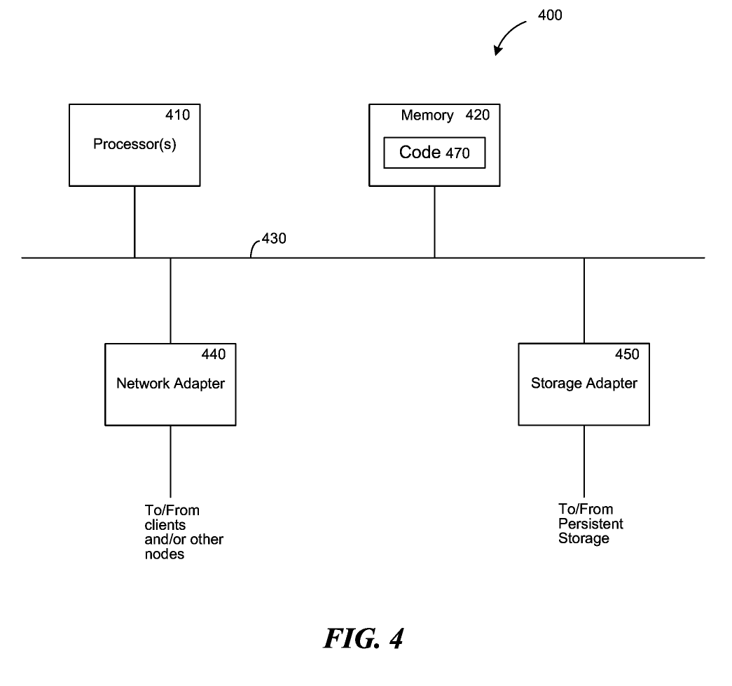

FIG. 4 is a block diagram of an example of a computing device 400, which may represent one or more computing device or server described herein, in accordance with various embodiments. The computing device 400 can be one or more computing devices that implement the wallet service server system 100 of FIG. 1 and/or the wallet service server system 200 of FIG. 2. The computing device 400 can implement methods and processes described in this disclosure (e.g., the method 300 of FIG. 3). The computing device 400 includes one or more processors 410 and memory 420 coupled to an interconnect 430. The interconnect 430 is an abstraction that represents any one or more separate physical buses, point-to-point connections, or both connected by appropriate bridges, adapters, or controllers. The interconnect 430, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or a “Firewire”.

The processor(s) 410 is/are the central processing unit (CPU) of the computing device 400 and thus controls the overall operation of the computing device 400. In certain embodiments, the processor(s) 410 accomplishes this by executing software or firmware stored in memory 420. The processor(s) 410 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 420 is or includes the main memory of the computing device 400. The memory 420 represents any form of random access memory (RAM), read-only memory (ROM), flash memory, or the like, or a combination of such devices. In use, the memory 420 may contain a code 470 containing instructions according to methods disclosed herein.

Also connected to the processor(s) 410 through the interconnect 430 are a network adapter 440 and a storage adapter 450. The network adapter 440 provides the computing device 400 with the ability to communicate with remote devices, over a network and may be, for example, an Ethernet adapter or Fibre Channel adapter. The network adapter 440 may also provide the computing device 400 with the ability to communicate with other computers. The storage adapter 450 enables the computing device 400 to access a persistent storage, and may be, for example, a Fibre Channel adapter or SCSI adapter.

The code 470 stored in memory 420 may be implemented as software and/or firmware to program the processor(s) 410 to carry out actions described above. In certain embodiments, such software or firmware may be initially provided to the computing device 400 by downloading it from a remote system through the computing device 400 (e.g., via network adapter 440).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification.

What is claimed is:

1. A computer system, comprising:
one or more processors; and
non-transitory memory configured to store executable instructions,
wherein the processors, when configured by the executable instructions, are operable to:
process a cryptocurrency deposit into a cryptocurrency wallet account maintained in a wallet service server system, wherein said processing includes receiving one or more authentication parameters to authenticate the cryptocurrency deposit and wherein said processing of the cryptocurrency deposit includes recording a transfer of a cryptocurrency amount from a first cryptocurrency address to a second cryptocurrency address that corresponds to the cryptocurrency wallet account in a public ledger maintained by a distributed consensus network, the public ledger being a chain of transaction record blocks, wherein a sequential order of the transaction record blocks is verifiable utilizing a proof-of-work process;
in response to and substantially immediately after authenticating the authentication parameters, automatically generate a first conversion transaction to exchange, at a first cryptocurrency exchange server system, the cryptocurrency amount associated with the cryptocurrency deposit for fiat currency proceeds;
send an electronic message to deposit the fiat currency proceeds from the first conversion transaction into a fiat reserve account, wherein the fiat currency proceeds is measured in units of a fiat currency type;
associate an exchangeable credit, measured in the units of the fiat currency type and equal to the fiat currency proceeds, to the cryptocurrency wallet account; and
in response to receiving a user-initiated request to spend a target portion of the exchangeable credit associated with the cryptocurrency wallet account, generate a second conversion transaction funded by the fiat reserve account to exchange for cryptocurrency proceeds equal to the target portion at a second cryptocurrency exchange server system for at least a portion of the exchangeable credit.

2. The computer system of claim 1, wherein the processors, when configured by the executable instructions, are further operable to deduct the target portion from the exchangeable credit in response to processing the second conversion transaction via the second cryptocurrency exchange server system.

3. The computer system of claim 1, wherein the processors, when configured by the executable instructions, are further operable to record a remittance transaction by transferring the cryptocurrency proceeds to a target wallet account specified by the user-initiated request.

4. A computer-implemented method comprising:
processing a cryptocurrency deposit into a cryptocurrency wallet account maintained in a wallet service server system, wherein said processing includes receiving one or more authentication parameters to authenticate the cryptocurrency deposit and wherein said processing of the cryptocurrency deposit includes recording a transfer of a cryptocurrency amount from a first cryptocurrency address to a second cryptocurrency address that corresponds to the cryptocurrency wallet account in a public ledger maintained by a distributed consensus network, the public ledger being a chain of transaction record blocks, wherein a sequential order of the transaction record blocks is verifiable utilizing a proof-of-work process;
in response to and substantially immediately after authenticating the authentication parameters, automatically generating a first conversion transaction to exchange, at a first cryptocurrency exchange server system, the cryptocurrency amount associated with the cryptocurrency deposit for fiat currency proceeds;
sending an electronic message to deposit the fiat currency proceeds from the first conversion transaction into a fiat reserve account, wherein the fiat currency proceeds is measured in units of a fiat currency type;
associating an exchangeable credit, measured in the units of the fiat currency type and equal to the fiat currency proceeds, to the cryptocurrency wallet account; and
in response to receiving a user-initiated request to spend a target portion of the exchangeable credit associated with the cryptocurrency wallet account, generating a second conversion transaction funded by the fiat reserve account to exchange for cryptocurrency proceeds equal to the target portion at a second cryptocurrency exchange server system for at least a portion of the exchangeable credit and deducting the target portion from the exchangeable credit.

5. The computer-implemented method of claim 4, wherein authenticating the authentication parameters includes authenticating a cryptographic signature against a corresponding public key associated with the second cryptocurrency address in the distributed consensus network.

6. The computer-implemented method of claim 4, wherein said authenticating is performed substantially immediately before said generating the first conversion transaction.

7. The computer-implemented method of claim 4, further comprising recording a remittance transaction by transferring the cryptocurrency proceeds to a target wallet account.

8. The computer-implemented method of claim 7, wherein the target wallet account is associated with another wallet service server system.

9. The computer-implemented method of claim 4, wherein processing the cryptocurrency deposit includes generating an electronic transaction to exchange for cryptocurrency to fund the cryptocurrency deposit, at a third cryptocurrency exchange server system, using fiat currency deposit from a financial account; wherein authenticating the authentication parameters includes authenticating the financial account; and wherein the fiat currency deposit is substantially equal to the fiat currency proceeds.

10. The computer-implemented method of claim 4, further comprising selecting the first cryptocurrency exchange server system from amongst multiple exchange server systems to maximize the fiat currency proceeds.

11. The computer-implemented method of claim 4, further comprising selecting the second cryptocurrency exchange server system from amongst multiple exchange server systems to maximize the cryptocurrency proceeds.

12. The computer-implemented method of claim 4, further comprising authenticating, via the wallet service server system, the exchangeable credit is available to be funded by the fiat reserve account maintained by an external financial service server system; and wherein the external financial service server system maintains accounting record of the fiat reserve account including a fiat currency amount measured in units of the fiat currency type.

13. The computer-implemented method of claim 4, wherein the first cryptocurrency exchange server system is the second cryptocurrency exchange server system.

14. The computer-implemented method of claim 4, wherein processing the cryptocurrency deposit includes determining the fiat currency type by querying for a user selection on a wallet interface of the wallet service server system; and wherein generating the first conversion transaction includes configuring the first conversion transaction based on the determined fiat currency type.

15. The computer-implemented method of claim 4, wherein processing the cryptocurrency deposit includes determining the fiat currency type based on an account profile of the cryptocurrency wallet account.

16. A computer-readable data storage medium storing computer-executable instructions that, when executed, cause a computer system to perform a computer-implemented method, the computer-executable instructions comprising:
instructions for processing a cryptocurrency deposit into a cryptocurrency wallet account maintained in a wallet service server system, wherein said processing includes receiving one or more authentication parameters to authenticate the cryptocurrency deposit and wherein said processing of the cryptocurrency deposit includes recording a transfer of a cryptocurrency amount from a first cryptocurrency address to a second cryptocurrency address that corresponds to the cryptocurrency wallet account in a public ledger maintained by a distributed consensus network, the public ledger being a chain of transaction record blocks, wherein a sequential order of the transaction record blocks is verifiable utilizing a proof-of-work process;
instructions for, in response to and substantially immediately after authenticating the authentication parameters, automatically generating a first conversion transaction to exchange the cryptocurrency amount associated with the cryptocurrency deposit for fiat currency proceeds at a first cryptocurrency exchange server system;
instructions for sending an electronic message to deposit the fiat currency proceeds from the first conversion transaction into a fiat reserve account, wherein the fiat currency proceeds is measured in units of a fiat currency type;
instructions for associating an exchangeable credit, measured in the units of the fiat currency type and equal to the fiat currency proceeds, to the cryptocurrency wallet account; and
instructions for, in response to receiving a user-initiated request to spend a target portion of the exchangeable credit associated with the cryptocurrency wallet account, generating a second conversion transaction funded by the fiat reserve account to exchange for cryptocurrency proceeds equal to the target portion at a second cryptocurrency exchange server system for at least a portion of the exchangeable credit and deducting the target portion from the exchangeable credit.

17. The computer-readable data storage medium of claim 16, wherein instructions for authenticating the authentication parameters includes instructions for authenticating a cryptographic signature against a corresponding public key associated with the second cryptocurrency address in the distributed consensus network.

18. The computer-readable data storage medium of claim 16, further comprising instructions for selecting the first cryptocurrency exchange server system from amongst multiple exchange server systems to maximize the fiat currency proceeds.

19. The computer-readable data storage medium of claim 16, further comprising instructions for selecting the second cryptocurrency exchange server system from amongst multiple exchange server systems to maximize the cryptocurrency proceeds.

20. The computer-readable data storage medium of claim 16, further comprising instructions for recording a remittance transaction by transferring the cryptocurrency proceeds to a target wallet account.
